(19) United States
(12) Patent Application Publication
(10) Pub. No.: US 2014/0268632 A1
(43) Pub. Date: Sep. 18, 2014

(54) LIGHT APPARATUS WITH INDENTATION

(71) Applicant: Jianqiao YANG, Scarborough (CA)

(72) Inventor: Jianqiao YANG, Scarborough (CA)

(21) Appl. No.: 13/837,744

(22) Filed: Mar. 15, 2013

(51) Int. Cl. F21V 11/00; F21V 13/02

(52) U.S. Cl. CPC F21V 11/00; F21V 13/02
USPC 362/84; 362/311.01; 362/235

(57) ABSTRACT

A light apparatus is provided for displaying a design when the light apparatus is illuminated by a light source. In an example embodiment, the light apparatus includes a wall having a first surface and a second surface opposite to the first surface, a light source positioned behind the wall and the first surface facing the light source, the first surface of the wall comprising an indentation extending into the wall and ending before the second surface, and the indentation forming a design in the wall. In an example embodiment, the light apparatus is a lamp. In another example embodiment, the light apparatus further includes a photoluminescent layer positioned within the indentation.

### TECHNICAL FIELD

The following generally relates to a light apparatus.

### DESCRIPTION OF THE RELATED ART

Lithophane is a form of art wherein a pattern engraved on a surface of a translucent material reveals an artwork to a viewer when the engraved material is backlit by a light source. For example, a lithophane includes an engraved viewing surface and an unengraved back surface. The front surface is generally engraved to form grooves of varying depth, while the unengraved back surface is left substantially uniform. When displayed, the lithophane is positioned in front of a light source such that the engraved viewing surface faces the viewer, and the unengraved back surface faces the light source to be illuminated. This way, light is partially transmitted through the lithophane, revealing a pattern of bright and dark portions accord to the depths of the grooves formed on the viewing surface.

Lithophane may be a stand-alone article to be displayed by placing the article between the eye and a light source, or it may be integrated within a building as part of a wall or as part of an object, such as a lamp, for example.

### BRIEF DESCRIPTION OF THE DRAWINGS

Example embodiments of a light apparatus will now be described by way of example only with reference to the accompanying drawings in which:

FIG. 1A is a diagram illustrating the light apparatus in an example embodiment.

FIG. 1B is a front view of the viewing surface of the light apparatus in an example embodiment.

FIG. 2A is a perspective view of a light apparatus in an example embodiment wherein designs are viewable on both the lampshade and the body.

FIG. 2B is a cross-sectional view of the light apparatus shown in FIG. 2A taken at line I-I.

FIG. 2C is a perspective view of a light apparatus in an example embodiment wherein a light source is in an off-condition.

FIG. 2D is a perspective view of a light apparatus in an example embodiment wherein a design is viewable on the body.

FIG. 2E is a perspective view of a light apparatus in an example embodiment wherein a design is viewable on the lampshade.

FIG. 3A is a perspective view of a light apparatus in an example embodiment wherein designs are viewable on an elongated body.

FIG. 3B is a cross-sectional view of the light apparatus shown in FIG. 3A taken at line II-II.

FIG. 3C is a perspective view of a light apparatus in an example embodiment wherein the light sources are in the off-condition.

FIG. 4A is a perspective view of a light apparatus in an example embodiment wherein the light apparatus is a lamp and the designs are viewable on the lampshade, the body and the base.

FIG. 4B is a cross-sectional view of the lamp shown in FIG. 4A taken at line III-III.

FIG. 4C is a perspective view of a light apparatus in an example embodiment wherein the light sources are in the off-condition.

FIG. 4D is a perspective view of a light apparatus in an example embodiment wherein the designs are viewable on the body and the base.

FIG. 4E is a perspective view of a light apparatus in an example embodiment wherein the designs are viewable on the body.

FIG. 4F is a perspective view of a light apparatus in an example embodiment wherein the design is viewable on the lampshade.

FIG. 4G is a perspective view of a light apparatus in an example embodiment wherein the design is viewable on the base.

FIG. 4H is an electrical diagram illustrating the electrical circuit of the light apparatus in an example embodiment.

FIG. 5A is a perspective view of a light apparatus in an example embodiment wherein the light apparatus is an open-top lantern.

FIG. 5B is a cross-sectional view of the light apparatus shown in FIG. 5A taken at line IV-IV.

FIG. 5C is a perspective view of a light apparatus in an example embodiment wherein the light apparatus is an open-top lantern and a light source is in an off-condition.

FIG. 6A is a perspective view of a light apparatus in an example embodiment wherein the light apparatus is a closed-top lantern.

FIG. 6B is a cross-sectional view of the light apparatus shown in FIG. 6A taken at line V-V.

FIG. 6C is a top view of the light apparatus shown in FIG. 6A.

FIG. 6D is a perspective view of a light apparatus in an example embodiment wherein the light apparatus is a closed-top lantern and the light source is in an off-condition.

FIG. 7A is a front view of a light apparatus in an example embodiment wherein the light apparatus is a panel having an indentation forming text.

FIG. 7B is a front view of the panel shown in FIG. 7A wherein the light source is in the off-condition.

FIG. 8A is a front view of a light apparatus in an example embodiment wherein the light apparatus is a panel having an indentation forming a face.

FIG. 8B is a front view of the panel shown in FIG. 8A wherein the light source is in the off-condition.

FIG. 9A is a front view of a light apparatus in an example embodiment wherein the light apparatus is a panel having an indentation forming a graphic image.

FIG. 9B is a front view of the panel shown in FIG. 9A wherein the light source is in the off-condition.

FIG. 10A is a cross-sectional view of a light apparatus in an example embodiment wherein a photoluminescent layer is positioned to cover the surface of the indentation.

FIG. 10B is a cross-sectional view of a light apparatus in an example embodiment wherein a photoluminescent layer is positioned to fill at least a portion of the space defined by the indentation.

FIG. 10C is a cross-sectional view of a light apparatus in an example embodiment wherein a photoluminescent layer is positioned to substantially fill the space defined by the indentation.

FIG. 11A is a diagram illustrating a light apparatus in an example embodiment wherein the light apparatus includes a photoluminescent layer and the light source is in the off-condition.

FIG. 11B is a diagram illustrating a light apparatus in an example embodiment wherein the light apparatus includes a photoluminescent layer and the light source is in the on-condition.

FIG. 11C is a diagram illustrating a light apparatus in an example embodiment wherein the light apparatus includes a photoluminescent layer emitting light.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

As previously mentioned, a lithophane is generally displayed by facing the engraved front surface towards the viewer and illuminating the unengraved back surface. However, displaying the lithophane with the engraved surface facing the viewer can be problematic in many circumstances.

Many intricate designs of lithophanes include delicate features such as sharp edges and narrow walls formed between adjacent grooves that produce fine patterns. These features can easily become damaged by coming in contact with various external objects, thus resulting in loss of details of the engraved artwork. In particular, when the lithophane is integrated as part of a furniture, a user can often come in contact with the engravings by accident when using the furniture, damaging the engravings.

It may also be desirable to display the lithophane in an outdoor environment. However, engravings can easily become damaged or weathered when displayed outdoors, and fine grooves may become filled with minerals and fine particles over time. The engraved surface is generally very difficult to clean and maintain without causing damage the engraved features, and it may quickly lose its appeal when it is not properly maintained.

It has also been recognized that traditional lithophane works can be difficult to integrate with certain articles or applications where a uniform surface is favorable over an engraved surface. For example, a lithophane cannot easily be integrated into a desk or a table since a flat, uniform surface is preferred in majority of circumstances. Example embodiments of a light apparatus are described herein to address at least one of these issues.

It will be appreciated that the terms “light apparatus”, “lamp” and “panel” may be used interchangeably to refer to specific embodiments of the light apparatus. It will also be appreciated that different features of the example embodiments of the light apparatus, as described herein, may be combined with each other in different ways. In other words, a feature described with respect to one embodiment of a light apparatus can be applied to another embodiment of a light apparatus, although not specifically stated.

FIGS. 1A and 1B illustrate the basic operation of a light apparatus in an example embodiment. FIG. 1A shows a cross-sectional diagram of a wall 1 of the light apparatus and FIG. 1B shows a front view diagram of the wall 1 of the light apparatus, for example, as seen by the eye 19.

FIG. 1A shows a cross-sectional diagram of a wall 1 of the light apparatus having a first surface 3 and a second surface 2, the second surface 2 being opposite to the first surface 3. In various example embodiments, the first surface and the second surface may also be referred to as an internal surface and an external surface, an interior surface and an exterior surface, or an indented surface and a viewing surface, respectively. In the illustrated example embodiment, the second surface 2 is shown as being a smooth flat surface and the first surface 3 is shown as having an indentation 7 forming a design thereon. The indentation 7 generally extends into the wall 1 and ends before reaching the second surface 2. The profile of the indentation 7 may vary between different example embodiments, and thus the cross-sectional profile of the indentation 7 is shown in FIG. 1A as an example only.

A first thickness of the wall 9 is generally defined between the first surface and the second surface. In other words, the first thickness of the wall 9 is determined by the distance between the two surfaces at a portion of the wall 1 that does not have the indentation 7 formed thereon. A second thickness of the wall 4 is generally defined between the indentation and the second surface. In other words, the second thickness of the wall 4 is determined by the distance between the indentation 7 and the second surface 2. In an example embodiment of the light apparatus, the depth of the indentation 7 may vary across the design such that the second thickness of the wall 4 also varies across the design. As such, the second thickness of the wall 4 may be any thickness of the wall defined between the indentation 7 and the second surface 2. For example, a number of different thicknesses are shown with arrows as the second thickness of the wall 4 in FIG. 1A. It is appreciated that the second thickness of the wall is less than the first thickness of the wall.

In use, the wall 1 is positioned between a light source 6 and a viewer such that the second surface 2 is viewable to the viewer. In other words, the light source 6 is positioned behind the wall 1 such that the first surface 3 faces the light source 6 as shown in FIG. 1A. The light source in an example embodiment is a light source which may be selectively controlled between an on-condition and an off-condition.

When the light source is in the on-condition, light is transmitted through the wall 1. However, there exists a variation in the brightness of the transmitted light due to the first surface 3 of the wall 1 having the indentation 7 formed thereon. The brightness of the transmitted light generally correlates with the thickness of the wall, meaning that greater transmission of light is achieved when the light is incident on the thinner indented portion of the wall compared to the thicker non-indented portion of the wall. In other words, light passing through the portion of the wall having the first thickness of the wall 9 will appear dimmer compared to light passing through the portion of the wall having the second thickness of the wall 4. Furthermore, the brightness of the transmitted light may also vary according to the depth of the indentation 7 formed on the first surface 3 of the wall. For example, when the indentation 7 is formed to extend deep into the wall 1 such that the second thickness of the wall 4 is relatively thin, the portion of the wall 1 having the deep indentation will appear to be relatively bright due to a greater transmission of light being achieved through that portion of the wall. Similarly, a portion of the wall having a shallow indentation formed thereon will appear to be relatively dim, or even dark, due to the second thickness of the wall 4 being relatively thick. It is also noted that for the same reason as stated above, the indented portion of the wall 1 in general will tend to appear brighter than the non-indented portion of the wall 1.

The variation in the brightness of the transmitted light as described above, results in the design 8 formed by the indentation 7 becoming viewable to the eye on the second surface 2 when the light source 6 is in the on-condition. The design 8 observed by the eye is shown more clearly in FIG. 1B. In an example embodiment, the design 8 corresponds to at least the shape of the indentation 7. However, in other embodiments, more intricate designs may be created by varying the depth of the indentation across the design such that the brightness of the transmitted light is non-uniform within the design. In other words, by varying the second thickness of the wall within the design, more sophisticated designs incorporating drastic and/or gradual changes in brightness may be created. For example, a sharp edge 5 is shown as being formed as part of the indentation 7 in FIG. 1A. When illuminated by the light source 6, the sharp edge 5 will tend to result in a sharp contrast in brightness due to a relatively large difference in the thickness of the wall between the sharp edge and the portion surrounding the sharp edge 5.

It can be seen that providing the indentation on a surface that faces away from the viewer results in the features of the indentation being less likely to become damaged by the viewer accidentally contacting the indentation. Additionally, the features of the indentation may further be protected by forming the indentation on a surface defining a substantially enclosed body as will be described in various example embodiments.

FIG. 2A shows an example embodiment of a light apparatus in form of a lamp having a lampshade 11 and a body 12. FIG. 2B shows a cross-sectional view of the light apparatus of FIG. 2A taken at line I-I.

As shown in FIG. 2B, the light apparatus includes a light source 15 housed within the body 12 and a primary lighting element 17 being supported on a holder 26. The lampshade 11 is shown as being mounted on the holder 26 by a lampshade mount 38 to substantially cover the primary lighting element 17. Although the light source 15, the primary lighting element 17 and the lampshade 11 are shown as being mounted on a common holder 26, various other mounting configurations may alternatively be used in other embodiments.

The body 12 of the light apparatus includes a wall 20 having a first surface and a second surface, the second surface being opposite to the first surface. In the example embodiment, the first surface is an interior surface 21 and the second surface is an exterior surface 23. The interior surface 21 of the body 12 is shown as having a first indentation 25 formed thereon. The first indentation 25 may be, for example, a groove formed on the interior surface 21 that extends into the base wall 20 and ends before reaching the exterior surface 23.

The light source 15 is configured to shine light onto the first indentation 25 formed on the interior surface 21, such as by positioning the light source 15 within the body 12 to face the light source 15 against the interior surface 21 as shown in FIG. 2B.

Similarly, the lampshade 11 of the light apparatus includes a lampshade wall 30 having an inner surface 31 and an outer surface 33. In the example embodiment shown in FIGS. 2A and 2B, the inner surface 31 also includes a second indentation 25 formed on the inner surface 31 which extends into the lampshade wall 30 and ends before reaching the outer surface 33.

The first and second indentations, referred to as “the indentation” herein, may be formed on the light apparatus and parts thereof using a number of different methods. For example, the indentation may be formed through chemical and/or physical etching process by selectively exposing portions of the light apparatus to be etched. The indentation may also be formed through manually engraving the surface using a tool or through the use of an automated tool such as a computer numerical control (CNC) system. In an example embodiment, the indentation may be formed during the production of the light apparatus. For example, the indentation may be formed by creating a corresponding protrusion on a mold used for forming a light apparatus. It will be appreciated that the method for forming the indentation may vary depending on factors such as the size, shape, and the material chosen for producing the light apparatus.

In an example embodiment, at least a portion of the light apparatus is made from stone. Stone may be artificial stone or natural stone, and stone may include, for example, jade, marble, limestone and granite. In an example embodiment, at least a portion of the light apparatus is made from a ceramic material. However, it will be appreciated that other types of materials may be used to produce the light apparatus and its various parts.

Returning to FIG. 2A, the light apparatus is shown in an on-condition wherein the light source is turned on and is emitting light. The primary lighting element is also shown as being turned on in the figure.

When the light source is in the on-condition, a first design 27 which corresponds to the design of the first indentation 25 becomes viewable to a viewer looking at the exterior surface 23 of the lamp. Similarly, a second design 37 corresponding to the design of the second indentation 25 formed on the lampshade wall 30 becomes viewable to the eye when the primary lighting element 17 is in the on-condition.

In an example embodiment of the light apparatus, the first design and the second design, simply referred to as “the design” herein, becomes viewable on the viewing surfaces of the body and the lampshade when the corresponding light sources are in the on-condition. This is, again, achieved by illuminating the indented surfaces such that the variation in the brightness of the transmitted light results in the design appearing on the viewing surfaces.

FIG. 2C shows an example embodiment of the light apparatus in an off-condition, in which the light source is turned off.

In the off-condition, the design may no longer viewable to the eye since there is substantially no light, or only a relatively small amount of light, being transmitted through the wall 20. In an example embodiment, both the first thickness of the wall, defined between the interior surface and the exterior surface of the wall, as well as the second thickness of the wall, defined between the indentation and the exterior surface, are sufficiently thick to at least substantially reduce or prevent ambient light from passing through. Ambient light is generally the level of light present in a typical indoor or outdoor environment. Ambient light may be direct light or indirect light, and the source of ambient light may include, for example, the sun, ceiling lights, and any other forms of lighting. The actual thickness of the wall required to substantially reduce or prevent ambient light from passing through may vary depending on the optical properties of the material used to produce the light apparatus.

By at least substantially reducing or preventing ambient light from passing through the wall, the light apparatus may appear as, for example, an ordinary lamp in the off-condition. Therefore, the viewer may be surprised to see a design emerge on the wall seemingly out of nowhere when the lamp is in the on-condition. This may add to the novelty and the appeal of the light apparatus.

In another example embodiment, at least one of the first thickness and the second thickness is sufficiently thin to enable some ambient light to pass through the wall of the light apparatus, thus enabling the designs to be viewed by the eye looking at the exterior surface, even when the light source is in the off-condition. However, the designs would not be as clearly seen compared to when the lights 15 and 17 are in an on-condition.

In an example embodiment, the exterior surface of the wall may be smooth as to provide a more uniform surface on which the design may be viewed.

FIG. 2D shows an example embodiment of the light apparatus with only the first indentation formed on the body 12, and the lampshade 11 does not have an indentation formed thereon. Therefore, only the first design 27 is viewable on the exterior surface 23 when the light source is in the on-condition.

In another example embodiment of the light apparatus, FIG. 2D shows the body 12 having the indentation forming the design 27 and the light source being in the off-condition. However, at least one of the first thickness of the wall and the second thickness of the wall is sufficiently thin to enable some ambient light to pass through the wall. Therefore, the design 27 is made viewable by the transmission of ambient light.

In another example embodiment of the light apparatus, FIG. 2D shows the body 12 having the first indentation forming the first design 27, the lampshade 11 having the second indentation forming the second design on the inner surface of the lampshade 11, and only the light source 15 housed within the body 12 being in the on-condition. As shown in the figure, the first design 27 is viewable on the exterior surface 23 of the body 12. However, the second design formed on the lampshade 11 is not viewable since the primary lighting element 17 is in the off-condition. Furthermore, the first thickness of the lampshade wall and the second thickness of the lampshade wall are made sufficiently thick to prevent ambient light from passing through the lampshade wall, thus making the second design not viewable when the primary lighting element is in the off-condition.

FIG. 2E shows an example embodiment of the light apparatus wherein the indentation 25 is formed on the lampshade wall and no indentation is formed on the body 12. Therefore, only the design 37 appears on the outer surface 33 of the lampshade when the primary lighting element is in the on-condition.

In another example embodiment of the light apparatus, FIG. 2E shows the lampshade 11 having the indentation forming the design 37 and the primary lighting element 17 being in the off-condition. However, at least one of the first thickness of the wall and the second thickness of the wall is sufficiently thin to enable some ambient light to pass through the wall, and thus enabling the design 37 to become viewable by the transmission of ambient light.

In another example embodiment of the light apparatus, FIG. 2E shows the body 12 having the first indentation forming the first design, the lampshade 11 having the second indentation forming the second design 37 on the inner surface of the lampshade 11, and only the primary lighting element 17 covered by the lampshade 11 being in the on-condition. As shown in the figure, the second design 37 is viewable on the outer surface 33 of the lampshade 11. However, the first design formed on the body 12 is not viewable since the light source 15 housed within the body 11 is in the off-condition. Furthermore, the first thickness of the wall and the second thickness of the wall are made sufficiently thick to prevent ambient light from passing through the wall of the body, thus making the first design not viewable when the light source 15 is in the off-condition.

It will be understood that the size, shape, position, and other general configurations of the design and the light apparatus shown in the figures are examples only, and that these parameters may be varied between different embodiments.

FIG. 3A shows an example embodiment of the light apparatus wherein the body 42 of the light apparatus is a substantially elongated member having at least an interior surface 44 and an exterior surface 46. The interior and exterior surfaces are shown in FIG. 3B, which is a cross-sectional view of the light apparatus taken at line II-II.

As shown in FIG. 3B, the light apparatus includes a first indentation 51 formed on the interior surface 44 near the upper portion of the body, a second indentation 54 formed on the interior surface 44 near the middle portion of the body and a third indentation 57 formed on the interior surface 44 near the lower portion of the body. Adjacent to each indentation, a corresponding light source is positioned such that the light sources are housed within the body 42 and each light source is primarily adapted to illuminate the corresponding indentation. More specifically, a first light source 60 is primarily adapted to illuminate the first indentation 50, a second light source 63 is primarily adapted to illuminate the second indentation 53 and a third light source 67 is primarily adapted to illuminate the third indentation 57. In the example embodiment shown in FIG. 3B, each light source is positioned closer to its corresponding indentation than other light sources. In other words, for example, the distance between the first light source 60 and the first indentation 50 is less than the distance between the second light source 63 and the first indentation 50, as well as the distance between the third light source 67 and the first indentation 50. The second and third light sources are similarly positioned near their corresponding indentations.

Returning to FIG. 3A, the light apparatus in the on-condition is shown. In the illustrated example embodiment, the first, second and third light sources are turned on to transmit light through at least the first, second and third indentations, respectively. As previously described, light is selectively transmitted through each of the indentations to make the corresponding images viewable on the external surface 44. More specifically, a first design 51 corresponding to the first indentation 50, a second design 54 corresponding to the second indentation 53 and a third design 58 corresponding to the third indentation 57 become viewable when the light apparatus is in the on-condition.

Although all three light sources are shown as being on in the on-condition shown in FIG. 3A, each light source may also be independently and selectively turned on and off. For example, the first light source 60 may be turned on to primarily illuminate the first indentation 50 to make the first design 51 viewable while keeping the second light source 63 and the third light source 67 turned off.

In an example embodiment, the light sources may be selectively toggled between the on-condition and the off-condition using a switch. A variety of switches may be used including, for example, a pole switch, a rotary switch, a push-button switch, or a solid state switch. The switch may further include, for example, a control circuit for enabling the switch to function as a multi-stage switch, such that multiple light sources may independently be controlled by the same switch. In a multi-stage push-button switch, for example, pressing the button for the first time may only turn on the first light source. However, pressing the button for the second time may turn on the second light source while keeping the first light source turned on. Similarly, pressing the button for the third time may turn the third light source on while keeping both the first and second light sources on, and so on.

FIG. 3C shows the light apparatus in an example embodiment in the off-condition, wherein all three light sources are turned off. Since no light is being transmitted through the body 42, the designs are not visible to the eye. However, in other embodiments, at least one of the first thickness of the wall and the second thickness of the wall may be sufficiently thin to enable ambient light to pass through the wall of the body, enabling the viewer to view at least one of the designs.

FIG. 4A shows an example embodiment of a light apparatus in form of a lamp having a base 70, a body 72 supported by the base, and a lampshade 74 positioned on top of the body. FIG. 4B is a cross-sectional view of the light apparatus shown in FIG. 4A taken at line III-III.

As is more clearly shown in FIG. 4B, the lamp includes a primary lighting element 90 mounted on a holder 76 supported by the body 72. The lampshade 74 is mounted on the holder 76 by a lampshade mount 75 to substantially cover the primary lighting element 90.

The body 72 of the lamp defines at least a void for housing a light source within. In the illustrated example embodiment, the body 72 is shown as having a first void 82 for housing a first light source 92 and a second void 84 for housing a second light source 94. The body 72 is further supported by the base 70 which similarly defines a base void 86 for housing a base light source 96.

Similarly with the previous embodiments, the interior surface of at least one of the lamp walls include an indentation extending into the wall and ending before reaching the exterior surface. In FIG. 4B, a first indentation 100 is shown as being formed on the interior surface of the lampshade 74, a second indentation 102 is shown as being formed on the interior surface of the portion of the body defining the first void 82, a third indentation 104 is shown as being formed on the interior surface of the portion of the body defining the second void 84 and a fourth indentation 106 is shown as being formed on the interior surface of the portion of the base defining the base void 86.

As shown in FIG. 4A, each indentation enables a corresponding design to become viewable to the eye looking at the exterior surface of the lamp when the lamp is in the on-condition. More specifically, illuminating the first indentation 100 results in a first design 110 to become viewable, illuminating the second indentation 102 results in a second design 112 to become viewable, illuminating the third indentation 104 results in a third design 114 to become viewable and illuminating the fourth indentation 106 results in a fourth design 116 to become viewable. In an example embodiment, each indentation may be illuminated by a corresponding light source. For example, the first indentation 100 may be illuminated by the primary lighting element 90, the second indentation 102 may be illuminated by the first light source 92, the third indentation 104 may be illuminated by the second light source 94 and the fourth indentation 106 may be illuminated by the base light source 96. In another example embodiment, two or more indentations may be illuminated by the same light source.

FIG. 4A shows all four light sources being turned on to make all four designs viewable. However, it will be noted that each light source may be configured to be selectively turned on or off independently of one another using, for example, the switch that was previously described. Although not shown in the figures, the lamp in an example embodiment may include a switch located on the body of the lamp. In another embodiment, the lamp may include a switch located on the base. In other example embodiments, the switch may also be located on the holder for mounting the primary light element. In any one of those cases, the user comes in contact with the lamp in order to manipulate the switch as long as the switch is located on a portion of the lamp. As previously described, the user had to take extra caution not to brush up against the engravings formed on the exterior surface of lithophane lamps when manipulating the switch. However, the risk of damaging the engravings or the indentations while manipulating the switch is significantly reduced by forming the indentations on the interior surface of the walls. Depending upon the configuration of the switch and the design of the lamp, it may be virtually impossible for the user to come in contact with indentations, and therefore fine or delicate features of the indentation may remain intact for a longer period of time. Additionally, an indentation positioned within a void, for example, is generally protected from being exposed to the outside environment. Therefore, delicate features formed by the indentation are much less likely to become damaged due to weathering or become clogged by dirt and dust particles.

FIG. 4C shows the lamp in the off-condition according to an example embodiment. All light sources are shown as being turned off, therefore there is substantially no light being transmitted through the walls and designs are not viewable to the eye looking at the external surface of the walls.

FIG. 4D shows an example embodiment of the lamp having indentations formed on the body 72 and the base 70, but not on the lampshade 74. Similarly with the previous embodiment described above, indentations are formed on the interior surfaces of the wall of the body 72 as well as the wall of the base 70 to enable designs 112, 114, 116 to become viewable when the lamp is in the on-condition.

In another example embodiment of the lamp, FIG. 4D shows a lamp having indentations formed on the lampshade 74, the body 72 and the base 70, and only the light sources housed within the body 72 and the base 70 being in the on-conditions. In other words, the primary lighting element is in the off-condition. Furthermore, the first thickness of the lampshade wall and the second thickness of the lampshade wall are both made sufficiently thick to prevent ambient light from passing through the lampshade 11. As a result, no ambient light is transmitted through the lampshade wall to make the design formed by the indentations on the lampshade viewable to the eye. However, the designs 112, 114, 116 formed by the indentations on the indented surfaces of the body and the base are viewable to the user.

In another example embodiment of the lamp, FIG. 4D shows a lamp having indentations formed on the body 72 and the base 70, but not on the lampshade 74, and the light sources being in the off-condition. Furthermore, at least one of the first thickness of the wall or the second thickness of the wall is made sufficiently thin to enable ambient light to pass through the body 72 and the base 70. As a result, transmitted ambient light makes the designs 112, 114, 116 viewable to the eye even when the light sources are in the off-condition.

FIG. 4E shows an example embodiment of the lamp having indentations formed on the body 72, but not on the base 70 or the lampshade 74. Similarly with the previous embodiments described above, indentations are formed on the interior surfaces of the wall of the body 72 defining the voids to enable designs 112, 114 to become viewable when the lamp is in the on-condition.

In another example embodiment of the lamp, FIG. 4E shows a lamp having indentations formed on the lampshade 74, the body 72 and the base 70, and only the light sources housed within the body 72 being in on-condition. In other words, the primary lighting element and the light source housed within the base are in the off-condition. Furthermore, the first thickness of the wall and the second thickness of the wall are both made sufficiently thick to prevent ambient light from passing through the lampshade 74 and the base 70. As a result, no ambient light is transmitted through the lampshade wall and the base wall to make the designs formed by the indentations on the lampshade and the base viewable to the eye. However, the designs 112, 114 formed by the indentations on the indented surface of the body are viewable to the eye.

In another example embodiment of the lamp, FIG. 4E shows a lamp having indentations formed on the body 72, but not on the lampshade 74 and the base 70, and all of the light sources being in the off-condition. Furthermore, at least one of the first thickness of the wall or the second thickness of the wall is made sufficiently thin to enable ambient light to pass through the body 72. As a result, transmitted ambient light makes the designs 112, 114 viewable to the eye even when the light sources are in the off-condition.

FIG. 4F shows an example embodiment of the lamp having indentations formed on the lampshade 74, but not on the base 70 or the body 72. Similarly with the previous embodiments described above, indentations are formed on the interior surface of the wall of the lampshade 74 to enable the design 110 to become viewable when the primary lighting element is in the on-condition.

In an example embodiment of the lamp, FIG. 4F shows a lamp having indentations formed on the lampshade 74, the body 72 and the base 70, and only the primary lighting element covered by the lampshade 74 is in the on-condition. In other words, the light sources housed within the base and the body are in the off-condition. Furthermore, the first thickness of the wall and the second thickness of the wall are both made sufficiently thick to prevent ambient light from passing through the body 72 and the base 70. As a result, no ambient light is transmitted through the body wall and the base wall to make the designs formed by the indentations on the body and the base viewable to the eye. However, the design 110 formed by the indentations on the indented surface of the lampshade is viewable to the user.

In another example embodiment of the lamp, FIG. 4F shows a lamp having indentations formed on the lampshade 74, but not on the body 72 and the base 70, and the primary lighting element is in the off-condition. Furthermore, at least one of the first thickness of the wall and the second thickness of the wall is made sufficiently thin to enable ambient light to pass through the lampshade 74. As a result, transmitted ambient light makes the design 110 viewable to the eye even when the primary lighting element.

FIG. 4G shows an example embodiment of the lamp having indentations formed on the base 70, but not on the body 72 or the lampshade 74. Similarly with the previous embodiments described above, indentations are formed on the interior surface of the wall of the base 70 to enable design 116 to become viewable when the base light source is in the on-condition.

In another example embodiment of the lamp, FIG. 4G shows a lamp having indentations formed on the lampshade 74, the body 72 and the base 70, and only the light source housed within the base 70 being in the on-condition. In other words, the light sources housed within the body 72 and the primary lighting element covered by the lampshade 74 are in the off-condition. Furthermore, the first thickness of the wall and the second thickness of the wall are both made sufficiently thick to prevent ambient light from passing through the body 72 and the lampshade 74. As a result, no ambient light is transmitted through the body wall and the lampshade wall to make the designs formed by the indentations on the body and the lampshade viewable to the eye. However, the design 116 formed by the indentations on the indented surface of the base is viewable to the user.

In another example embodiment of the lamp, FIG. 4G shows a lamp having indentations formed on the base 70, but not on the body 72 and the lampshade 74, and the light source housed within the base being in the off-condition. Furthermore, at least one of the first thickness of the wall or the second thickness of the wall is made sufficiently thin to enable ambient light to pass through the base 70. As a result, transmitted ambient light makes the design 116 viewable to the eye even when the light source housed in the void of the base 70 is in the off-condition.

The light source may generally be any element enabled to emit light. For example, the light source may be a light emitting diode (LED) or a light bulb. In an example embodiment, the light apparatus may include different types of light sources. For example, the light apparatus may have an incandescent light bulb as the primary lighting element and a fluorescent tube as a light source housed within the body. The light apparatus may also include light sources which emit light at different wavelengths from one another in an example embodiment. In other words, light emitted by one light source of the light apparatus has a different color than light emitted by another light source of the light apparatus. For example, the light apparatus may include a red LED, a blue LED and a green LED, each adapted to illuminate the corresponding indentation formed on the interior surface of the wall.

In an example embodiment of a lighting apparatus having two or more light sources or lighting elements, the primary lighting element is brighter than the light source housed within the body or the base. In other words, the brightness of the light being emitted from the primary lighting element is greater than the perceived brightness of light being emitted from any other light sources of the lighting apparatus. However, this does not necessary require the primary lighting element itself to output greater luminous flux than any of the other light sources of the lighting apparatus. For example, this is achieved in one example embodiment wherein the wall of the base or the body of the lighting apparatus causes light being emitted by the light source housed within the wall to scatter or diffract. This results in the light source housed within the wall to appear as giving off a softer glow, and therefore dimmer than the primary lighting element. In another example embodiment, the output of the light source housed within the body or the base is lower than the output of the primary lighting element.

Having a dimmer light source housed within the body or the base may be desirable in circumstances where the user wishes to only have a dim light on. For example, light emitted from the body or the base may be sufficient for locating objects nearby the light apparatus, such as an alarm clock. Therefore, the user may locate the alarm clock using only the dim light source to set the alarm without turning on the brighter primary lighting element, as turning the primary lighting element on may interfere with the user's sleep and the relaxed atmosphere of the room. Additionally, the dim light source may be left on while the user sleeps such that when the user wakes up, the room will not be completely dark and the user will be able to easily re-orient himself.

FIG. 4H illustrates an electrical circuit diagram of the light apparatus in one example embodiment. The light apparatus is shown as having a first light source 251, a second light source 253, a third light source 255 and a fourth light source 257 being connected parallel to one another. Each light source has a corresponding switching element shown as S1-S4 for at least selectively turning on and off each of the light sources independently from one another. For example, the first light source 251 is controlled by switching element S1 and the second light source 253 is controlled by switching element S2, and so on. In this way, each light source may be controlled independently from one another when the light apparatus is connected to a power source using terminals 258, 259. However, it will be appreciated that the circuit diagram is shown as an example only, and other circuit configurations may alternatively be used.

As previously described, the switching element may be, for example, a multi-stage switch, a pole switch, a rotary switch, a push-button switch, or a solid state switch. In an example embodiment, the switching element may include a variable resistor which may be adjusted to vary the brightness of the corresponding light source.

FIG. 5A shows an example embodiment of a light apparatus in form of an open-top lantern. FIG. 5B is a cross-sectional view of the open-top lantern taken at line IV-IV.

As shown in FIG. 5B, the open-top lantern includes a light source 130 housed within a wall 132 having an exterior surface 134 and an interior surface 136. The wall in the example embodiment is shown as having at least four sides to substantially encompass the light source 130. The walls are shown as being supported between vertical support members 135. Furthermore, each side of the wall includes an indentation 138 formed on its interior surface 136 which extends into the wall 132 and ends before reaching the exterior surface 134. The indentation positioned on the interior surface 136 of the wall 132 forms a design 140, which becomes viewable on the external surface 134 when the light source is in the on-condition as shown in FIG. 5A.

However, as shown in FIG. 5C, the design may not be viewable when the light source is in the off-condition. Similarly with the previous embodiment of the light apparatus, the first thicknesses of the wall defined between the interior surface 136 and the exterior surface 134 as well as the second thickness of the wall defined between the indentation and the exterior surface 134 may be sufficiently thick so as to at least substantially reduce or prevent ambient light from passing through the wall. This ensures that the design is only viewable from the external surface 134 when the light source is in the on-condition, and the lantern may appear as an ordinary lantern when the light source is in the off-condition. This feature may add to the novelty of the lantern as the design will appear seemingly out of nowhere when the lantern is turned on.

In another example embodiment, at least one of the first thickness of the wall and the second thickness of the wall may be sufficiently thin to enable ambient light to pass through the wall, thus enabling the design 140 to be viewable even when the light source 130 is in the off-condition.

FIG. 6A shows an example embodiment of a lantern having a closed top. FIG. 6B is a cross-sectional view of the closed-top lantern taken at line V-V.

As shown in FIG. 6B, the closed-top lantern includes a light source 150 housed within a wall 152 having an exterior surface 154 and an interior surface 156. The wall in the example embodiment is shown as having at least four sides and a top to substantially encompass the light source 150 within. The walls are supported by vertical support members 155. Each side of the wall includes an indentation 158 formed on its interior surface 156 which extends into the wall 152 and ends before reaching the exterior surface 154. Similarly, the top includes the indentation 158 formed on its interior surface 156 as well. The indentation positioned on the interior surface 156 of the wall 152 forms a design 160, which becomes viewable to the eye on the external surface 154 when the light source is in the on-condition as shown in FIG. 6A.

FIG. 6C shows a top view of the closed top lantern with the light source in the on-condition. When the light source is in the on-condition, the design 160 of the indentation formed on the interior surface of the top wall becomes viewable as shown in the figure.

FIG. 6D shows the closed top lantern with the light source in the off-condition in an example embodiment. Here, both the first thickness of the wall and the second thickness of the wall are sufficiently thick to at least substantially reduce or prevent ambient light from passing through the wall. Therefore, the design is only viewable when the light source is turned on.

However, in another example embodiment, at least one of the first thickness of the wall and the second thickness of the wall may be sufficiently thin to enable ambient light to pass through the wall, thus enabling the design 160 to be viewable even when the light source 150 is in the off-condition.

Although the designs of the indentations formed on the walls were labeled using the same numeral, each design may vary in other embodiments. For example, the design on each wall may all be a different design, or the side walls may have identical designs while the top wall may have a design different from that of the side walls.

The construction of the lantern may vary in different embodiments. In one example embodiment, the lantern may include a frame defining the corners of the lantern and the frame being adapted to hold the sidewalls in upright positions between the corners. The lantern may be formed, for example, by fitting the sidewalls having the indentations onto the frame such that the light source is substantially encompassed by the sidewalls and the frame.

Various example embodiments of a light apparatus in form of a panel are shown in FIGS. 7-9. It will be appreciated that the panel is generally referenced by numeral 180, and different suffixes ‘a’, ‘b’, ‘c’ are used to refer to different embodiments of the panel 180.

FIG. 7A is a front view of a light apparatus in form of a panel 180a wherein the panel has a viewing surface 182 and an indented surface having an indentation formed thereon. The indentation is formed such that it extends into the wall and ends before reaching the viewing surface. In this way, the indentation forms a design which may be viewed by a viewer facing the viewing surface by illuminating the indented surface with a light source. FIG. 7A shows an example embodiment wherein the design formed by the indentation is text 200.

When the indented surface is not illuminated by a light source, the viewing surface appears blank, as shown in FIG. 7B. However, illuminating the indented surface results in a variation in the brightness of light transmitted through the panel due to the presence of the indentation, thus the text 200 becomes viewable to the eye looking at the viewing surface 182. It is noted that the manner in which the text 200 becomes viewable depends on the nature of the indentation. For example, if only the outline of the text 200 is indented onto the panel, only the outline of the text 200 will appear brighter than the rest of the panel. However, if the panel 180a is indented such that the area defined by the outline of each letter of the text 200 is indented, individual letters of the text 200 will appear brighter than the rest of the panel 180.

FIG. 8A is a front view of a light apparatus in form of a panel 180b wherein the design formed by the indentation is a cartoon 210 such as a smiling face. Similarly with the previous embodiment, the panel 180b appears blank when the indented surface is not illuminated, as shown in FIG. 8B. However, the cartoon 210 becomes viewable on the viewing surface 182 when the indented surface is illuminated as shown.

FIG. 9A is a front view of a light apparatus in form of a panel 180c wherein the design formed by the indentation is a graphic art 220 such as a picture of the globe. Similarly with the previous embodiment, the panel 180c appears blank when the indented surface is not illuminated, as shown in FIG. 9B. However, the graphic art 220 becomes viewable on the viewing surface 182 when the indented surface is illuminated as shown.

It will be appreciated that in each example embodiment of the panel, at least one of the first thickness of the wall and the second thickness of the wall may be made sufficiently thin to enable ambient light to pass through the panel wall, thus making the designs viewable even when the light source is in the off-condition.

In general, the designs made by the indentations can vary. Designs may also include logos for advertising.

The light apparatus in form of a panel may be used as a stand-alone article or may be integrated into an object. For example, the panel may be displayed as a sign for a store or as an advertisement at a bus stop or a street corner. The panel may also be integrated as part of a furniture, such as a desk or a table. The panel may be particularly suitable for display in an outdoor environment since the indented surface of the panel may be isolated from the environment relatively easily. For example, the panel may be fitted to cover an opening formed on a housing having a light source positioned within, such that the viewing surface is exposed to the environment but the indented surface and the light source are protected by the housing. In this way, the appearance of the exposed material may particularly appeal to the eye while the fragile features of the indentations will be protected from weathering and other erosion processes. Additionally, the viewing surface may be cleaned easily since it is a relatively uniform surface, facilitating the maintenance of the light apparatus.

In an example embodiment of the light apparatus, the indentation may further include a photoluminescent material. In a preferred example embodiment, only the indentations have a photoluminescent material positioned therewithin. In other embodiments, not shown, the photoluminescent material is also located on the first surface as well as within the indentation.

FIG. 10A shows a cross-sectional view of a light apparatus having a photoluminescent layer. More specifically, a first indentation 261a formed on an indented surface of the light apparatus is lined with a first photoluminescent layer 261a and a second indentation 261b is lined with a second photoluminescent layer 261b.

The photoluminescent layer 251a, 251b includes a photoluminescent material such as, for example, a phosphorescent material. Phosphorescent material is generally a type of material which absorbs incident light having a first wavelength and re-emits light at a second wavelength different from the first wavelength over a relatively long period of time. In an example embodiment of the light apparatus, the photoluminescent material contains a rare earth element. Other photoluminescent materials which may be used include zinc sulfide, strontium aluminate and calcium sulfide, for example. The photoluminescent layer may also include other materials such as, for example, a binder or an adhesive for securing the photoluminescent material to the indentations.

In an example embodiment of the light apparatus, the photoluminescent layer is at least semi-transparent, meaning that the photoluminescent layer is substantially transparent or translucent. In other words, the photoluminescent layer does not significantly scatter or absorb light at visible wavelengths. This feature enables the presence of the photoluminescent layer to have minimal impact on the design formed by the indentation when the indented surface is illuminated by a light source. Thus, when the light source is in the on-condition, light can pass through the photoluminscent material and through the second thickness of the wall, to reach the eye of the viewer looking at the second surface.

FIG. 10B shows an example embodiment of the light apparatus having a photoluminescent layer filling at least a portion of the space defined by the indentation. In particular, a first photoluminescent layer 253a is shown as filling at least a portion of the space defined by a first indentation 263a and a second photoluminescent layer 253b is shown as filling at least a portion of the space defined by a second indentation 263b.

Similarly, the photoluminescent layer may substantially fill the space defined by the indentation as shown in FIG. 10C. More specifically, a first photoluminescent layer 255a is shown as filling the space defined by a first indentation 265a and a second photoluminescent layer 255b is shown as filling the space defined by a second indentation 265b.

FIGS. 11A-11C illustrates a series of diagrams showing the operation of a light apparatus having a photoluminescent layer.

FIG. 11A shows the light apparatus with the light source being in the off-condition. When the light source is off, the eye may still be able to partially see the design 280a on the viewing surface 285 due to ambient light being transmitted through the wall of the light apparatus. The design 280a corresponds to the design formed by the indentation on the indented surface of the apparatus, which in this case is a text.

In an example embodiment, both the first thickness of the wall and the second thickness of the wall are made sufficiently thick to at least reduce or prevent ambient light from passing through the wall, thus making the design viewable only when the light source is in the on-condition.

FIG. 11B shows the light apparatus with the light source in the on-condition. As previously described, the design 280b becomes clearly visible on the viewing surface 285 due to a variation in the brightness of the transmitted light.

FIG. 11C shows the light apparatus with the light source in the off-condition and, for example, after the light source had been in the on-condition for some time. As illustrated, the design 280c is still clearly visible to the eye looking at the viewing surface 280c even after the light source is turned off. This is achieved because the photoluminescent layer positioned within the indentation continues to emit light after the light source has is turned off. Since the photoluminescent layer is positioned within the indentation, the design 280c is substantially the same as the design 280b observed when the light source in in the on-condition.

The amount of time the light source is required to be in the on-condition for this effect to be achieved may depend on a variety of factors such as the type and amount of photoluminescent material used, as well as the intensity of the light source. Similarly, the duration of time for which the photoluminescent material continues to emit light may vary depending upon similar factors as well. For example, the photoluminescent layer may continue to emit light for several hours after the light source has been turned off.

A light apparatus including a photoluminescent material may be particularly useful in circumstances where the user wishes to keep a dim light on after turning off all other light sources. Such light apparatus may also be desirable in circumstances where the power has been cut off without warning. For example, when there is an abrupt power outage, the user will not be left in darkness if the light apparatus had been in use prior to the power outage, since the photoluminescent layer will continue to emit some light even when there is no power. Using the light being emitted from the photoluminescent layer, the user may be able to navigate and find an alternative light source until the power comes back on. The photoluminescent material also helps the design to remain clearly visible longer, even after the light source is turned off. This can be advantageous for advertising.

Non-limiting general example embodiments will now be described, including example aspects of such embodiments.

In a general embodiment, a light apparatus includes a wall having a first surface and a second surface opposite to the first surface, a light source positioned behind the wall and the first surface facing the light source, the first surface of the wall comprising an indentation extending into the wall and ending before the second surface, and the indentation forming a design in the wall.

In an aspect, the second surface of the wall is smooth.

In another aspect, the light apparatus further includes a photoluminescent material positioned within the indentation, the photoluminescent material being adapted to absorb light from at least the light source when the light source is in an on-condition and emit light at least when the light source is in an off-condition.

In a further aspect, the photoluminescent material is at least semi-transparent.

In another aspect, the design is only viewable to the eye from the second surface when the light source is in the on-condition.

In another aspect, a first thickness of the wall is defined between the first surface and the second surface, and a second thickness of the wall is defined between the indentation and the second surface, and wherein both the first thickness and the second thickness of the wall do not permit ambient light to pass through.

In a further aspect, the second thickness of the wall permits a greater amount of light from the light source to pass through compared to the first thickness of the wall.

In another aspect, the wall includes natural stone.

In another aspect, the wall includes any one of jade, marble, limestone, and granite.

In another aspect, the design includes text.

In another aspect, the wall forms a base of a lamp.

In another aspect, the first surface of the wall further includes an other indentation extending into the wall and ending before the second surface, the other indentation forming an other design.

In a further aspect, the light apparatus further includes an other light source positioned behind the wall, the other light source positioned closer to the other indentation compared to the light source, and the light source positioned closer to the indentation compared to the other light source.

In another further aspect, the color of light emitted by the other light source is different than the color of light emitted by the light source.

In another aspect, the indentation is formed by at least one of etching and engraving.

In another aspect, the light source is at least one of a light bulb and a light emitting diode.

In another general embodiment, a lamp is provided, the lamp including a body supporting a holder configured to hold a primary lighting element, the body including a wall, the wall having an interior surface and an exterior surface, a light source positioned within a void defined by the body, the interior surface of the wall having an indentation extending into the wall and ending before the exterior surface, and the indentation forming a design in the wall.

In an aspect, the exterior surface of the wall is smooth.

In another aspect, the lamp further includes a photoluminescent material positioned within the indentation, the photoluminescent material being adapted to absorb light from at least the light source when the light source is in an on-condition and emit light at least when the light source is in an off-condition.

In a further aspect, the photoluminescent material is at least semi-transparent.

In another aspect, the design is only viewable to the eye from the exterior surface when the light source is in an on-condition.

In another aspect, a first thickness of the wall is defined between the interior surface and the exterior surface, and a second thickness of the wall is defined between the indentation and the exterior surface, and wherein both the first thickness and the second thickness of the wall do not permit ambient light to pass through.

In a further aspect, the second thickness of the wall permits a greater amount of light from the light source to pass through compared to the first thickness of the wall.

In another aspect, the lamp further includes a switch to enable the primary lighting element to be activated independently from the light source.

In another aspect, the lamp further includes a switch located on at least one of the body and the holder.

In another aspect, the lamp further includes a base to support the body, the base including an other wall, the other wall having an other interior surface and an other exterior surface, an other light source positioned within a void defined by the base, the other interior surface of the wall comprising an other indentation extending into the other wall and ending before the other exterior surface; and the other indentation forming an other design in the wall.

In a further aspect, the lamp further includes a switch to activate the light source and the other light source independently from each other.

In another further aspect, the lamp of further includes a switch located on at least one of the body, holder and the base.

In another general embodiment, a lamp is provided, the lamp including a body supporting a holder configured to hold a primary lighting element, a base supporting the body, the base including a wall, the wall having an interior surface and an exterior surface, a light source positioned within a void defined by the base, the interior surface of the wall having an indentation extending into the wall and ending before the exterior surface, and the indentation forming a design in the wall.

It will be appreciated that the particular example embodiments shown in the figures and described above are for illustrative purposes only and many other variations can be used according to the example embodiments described herein. Although the above has been described with reference to specific example embodiments, various modifications thereof will be apparent to those skilled in the art as outlined in the appended claims.

1. A light apparatus comprising:
a wall comprising a first surface and a second surface opposite to the first surface;
a light source positioned behind the wall and the first surface facing the light source;
the first surface of the wall comprising an indentation extending into the wall and ending before the second surface; and
the indentation forming a design in the wall.

2. The light apparatus of claim 1 wherein the second surface of the wall is smooth.

3. The light apparatus of claim 1 further comprising a photoluminescent material positioned within the indentation, the photoluminescent material being adapted to absorb light from at least the light source when the light source is in an on-condition and emit light at least when the light source is in an off-condition.

4. The light apparatus of claim 3 wherein the photoluminescent material is at least semi-transparent.

5. The light apparatus of claim 1 wherein the design is only viewable to the eye from the second surface when the light source is in the on-condition.

6. The light apparatus of claim 1 wherein a first thickness of the wall is defined between the first surface and the second surface, and a second thickness of the wall is defined between the indentation and the second surface; and wherein both the first thickness and the second thickness of the wall do not permit ambient light to pass through.

7. The light apparatus of claim 1 wherein the wall comprises natural stone.

8. The light apparatus of claim 1 wherein the design comprises text.

9. The light apparatus of claim 1 wherein the wall forms a base of a lamp.

10. The light apparatus of claim 1 wherein the first surface of the wall further comprises an other indentation extending into the wall and ending before the second surface, the other indentation forming an other design.

11. The light apparatus of claim 10 further comprising an other light source positioned behind the wall, the other light source positioned closer to the other indentation compared to the light source, and the light source positioned closer to the indentation compared to the other light source.

12. The light apparatus of claim 1 wherein the indentation is formed by at least one of etching and engraving.

13. The light apparatus of claim 1 wherein the light source is at least one of a light bulb and a light emitting diode.

14. A lamp comprising:
a body supporting a holder configured to hold a primary lighting element;
the body comprising a wall, the wall comprising an interior surface and an exterior surface;
a light source positioned within a void defined by the body;
the interior surface of the wall comprising an indentation extending into the wall and ending before the exterior surface; and
the indentation forming a design in the wall.

15. The lamp of claim 14 wherein the exterior surface of the wall is smooth.

16. The lamp of claim 14 further comprising a photoluminescent material positioned within the indentation, the photoluminescent material being adapted to absorb light from at least the light source when the light source is in an on-condition and emit light at least when the light source is in an off-condition.

17. The light apparatus of claim 16 wherein the photoluminescent material is at least semi-transparent.

18. The lamp of claim 14 wherein the design is only viewable to the eye from the exterior surface when the light source is in an on-condition.

19. The lamp of claim 17 wherein a first thickness of the wall is defined between the interior surface and the exterior surface, and a second thickness of the wall is defined between the indentation and the exterior surface; and wherein both the first thickness and the second thickness of the wall do not permit ambient light to pass through.

20. The lamp of claim 14 further comprising a switch to enable the primary lighting element to be activated independently from the light source.

21. The lamp of claim 14 further comprising a switch located on at least one of the body and the holder.

22. The lamp of claim 14 further comprising: a base to support the body, the base comprising an other wall, the other wall comprising an other interior surface and an other exterior surface; an other light source positioned within a void defined by the base; the other interior surface of the other wall comprising an other indentation extending into the other wall and ending before the other exterior surface; and the other indentation forming an other design in the wall.

23. The lamp of claim 22 further comprising a switch to activate the light source and the other light source independently from each other.

24. The lamp of claim 22 further comprising a switch located on at least one of the body, holder and the base.

25. A lamp comprising:
a body supporting a holder configured to hold a primary lighting element;
a base supporting the body;
the base comprising a wall, the wall comprising an interior surface and an exterior surface;
a light source positioned within a void defined by the base;
the interior surface of the wall comprising an indentation extending into the wall and ending before the exterior surface; and
the indentation forming a design in the wall.
